(19) United States
(12) Patent Application Publication
(10) Pub. No.: US 2021/0291538 A1
(43) Pub. Date: Sep. 23, 2021

(54) LIQUID RECOVERY FROM ATTACHMENT ASSEMBLIES VIA SECONDARY VENT PORT

(71) Applicant: Hewlett-Packard Development Company, L.P., Spring, TX (US)

(72) Inventors: Kenneth Williams, Vancouver, WA (US); Steve A. O'Hara, Vancouver, WA (US)

(73) Assignee: Hewlett-Packard Development Company, L.P., Spring, TX (US)

(21) Appl. No.: 17/054,549

(22) PCT Filed: Aug. 30, 2018
(86) PCT No.: PCT/US2018/048790

§ 371 Date: Nov. 11, 2020

(51) Int. Cl. B41J 2/175

(52) U.S. Cl. CPC B41J 2/17523

(57) ABSTRACT

An example of apparatus including an attachment assembly to mate a liquid supply with a reservoir is provided. The apparatus includes an outlet port disposed on the attachment assembly, wherein the outlet port is to dispense liquid from the liquid supply to a receiving port of the reservoir. The apparatus includes a main vent port disposed on the attachment assembly, wherein the main vent port is to receive air from the reservoir as the liquid enters the reservoir. The apparatus includes a plug disposed on the attachment assembly, wherein the plug is to seal a secondary vent when the attachment assembly is mated with the reservoir, and wherein the plug is to break a seal with the secondary vent prior to detachment of the attachment assembly to recover the liquid from the attachment assembly.

### BACKGROUND

Imaging devices, such as printers, may deposit liquid on a medium to produce images. For example, a print fluid may be deposited on various types of paper to generate documents. Accordingly, imaging devices may include a storage for print fluid, such as a reservoir, from which liquid ink is deposited on the medium. Other types of imaging devices may include 3D printing devices. As the imagine device is used, the reservoir of liquid is depleted. The reservoir may be replaced or refilled for continued used of the imaging device.

### BRIEF DESCRIPTION OF THE DRAWINGS

Reference will now be made, by way of example only, to the accompanying drawings in which:

FIG. 1 is a cross section view of an example of an apparatus to mate a liquid supply with a reservoir;

FIG. 2 is a cross section view of another example of an apparatus in use to mate a liquid supply with a reservoir;

FIG. 3 is a cross section view of an example of a reservoir;

FIG. 4 is a flowchart of an example method of using an apparatus to mate a liquid supply with a reservoir;

FIG. 5 is an example of a system used to transfer liquid from an print fluid source to a reservoir;

FIGS. 6A-B is (a) an example of the system used to transfer liquid from an print fluid source to a reservoir and (b) a cross section view when a valve is in a closed position;

FIGS. 7A-B is (a) an example of the system used to transfer liquid from an print fluid source to a reservoir and (b) a cross section view when a valve is in a dispensing position; and

FIGS. 8A-B is (a) a cross section view when a valve is in a closed position after filling and (b) a cross section view when after breaking the seal of the secondary vent.

### DETAILED DESCRIPTION

Imaging apparatus, such as print systems, may use a liquid reservoir to store an amount of liquid, such as ink, fusing agents, and detailing agents, for use in printing applications. As the print systems generate documents using the liquid stored in the liquid reservoir, the liquid reservoir becomes depleted and eventually is to be filled. The filling process is not particularly limited and generally involves dispensing a liquid from a liquid source to fill the reservoir. During the filling process, the liquid source may include an attachment mechanism and a liquid supply to provide a seal between the liquid supply and the liquid reservoir such that liquid may be transferred without spillage.

It is to be appreciated that as the liquid flows from the liquid supply to the liquid reservoir, the liquid flows via conduits that connect the liquid supply to the liquid reservoir. Once the liquid reservoir has been filled by the liquid supply, the seal is broken and the liquid supply is removed from the liquid reservoir. Upon filling the liquid reservoir, liquid may remain in the conduit between the liquid supply and the liquid reservoir. Simply breaking the seal may result in the loss of the liquid and potentially leakage. Accordingly, the liquid remaining in the conduit may be recovered by allowing it to flow into the liquid reservoir prior to breaking the seal and disconnecting the liquid supply from the liquid reservoir.

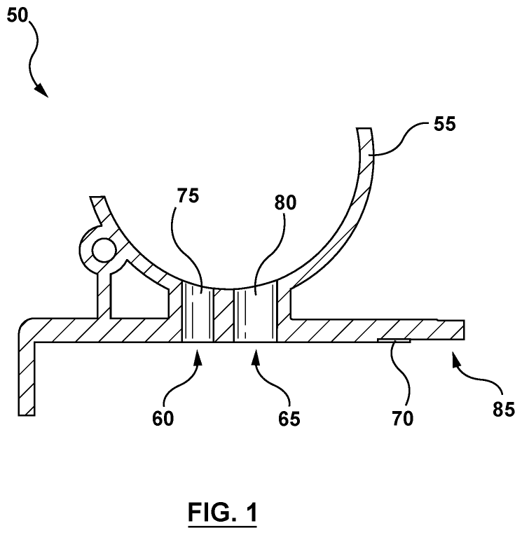

Referring to FIG. 1, an apparatus is generally shown at 50. The apparatus 50 is to transfer liquid from a liquid supply to a liquid reservoir. In particular, the liquid being transferred is an ink. In the present example, the apparatus 50 includes an attachment assembly 55 with a body having an outlet port 60, a main vent port 65 and a plug 70.

The attachment assembly 55 is a body to mate a liquid supply to a reservoir. In the present example, the attachment assembly 55 is connected to the liquid supply and designed to mate with an interface of a reservoir. In particular, the attachment assembly 55 may include guides and bosses (not shown) to mate with complementary guides and bosses on the interface of the reservoir. In other examples, the attachment assembly 55 may mate with the interface of the reservoir using other attachment mechanisms. For example, the attachment assembly 55 may be connected using a connector or fastener, such as a clipping mechanism or a screw or bolt. In another example, the attachment assembly 55 may mate with the interface of the reservoir using a friction fit.

The attachment assembly 55 is not particularly limited and may be manufactured using a wide variety of materials. In the present example, the attachment assembly 55 is a plastic and may be manufactured using various techniques such as injection molding or 3-D printing. In other examples, the attachment assembly 55 may be manufactured from composite materials or metals and/or alloys such as aluminum, steel, titanium or other metals.

The outlet port 60 is formed in the body of the attachment assembly 55. In the present example, the outlet port 60 is to dispense liquid from the liquid supply to a receiving port of the reservoir. Accordingly, the outlet port 60 may be designed to establish a sealed connection with the receiving port. The manner by which the outlet port 60 may establish the sealed connection is not particularly limited. For example, the outlet port 60 may include a raised edge to seal around the receiving port. As another example, the body of the attachment assembly 55 may be manufactured from a malleable material such that the application of pressure at the outlet port 60 creates a seal. In other examples, the outlet port 60 may also be made of a rubber material such as an O-ring to form a seal. Alternatively, the outlet port 60 may be to interact with a receiving port having any of the features described above.

In the present example, the outlet port 60 includes a conduit 75 to direct liquid through the body of the attachment assembly 55. Accordingly, during the filling process, the liquid flows through the conduit 75 and into the reservoir. Upon completion of the filling process, it is to be appreciated that some liquid may remain in the conduit 75 of the outlet port 60 when the flow of the liquid stops. In other examples, the outlet port 60 may be connected to other components such as a valve (not shown).

The main vent port 65 is formed in the body of the attachment assembly 55. In the present example, the main vent port 65 is to facilitate reception of the liquid via the receiving port of the reservoir. For example, the main vent port may receive air from a main vent of the reservoir as the liquid enters the reservoir via the outlet port 60. Accordingly, the main vent port 65 may be designed to establish a sealed connection with the main vent of the reservoir to exchange air between the reservoir and the liquid supply. The manner by which the main vent port 65 may establish the sealed connection is not particularly limited. For example, the main vent port 65 may include a raised edge to seal around the vent of the reservoir. As another example, the body of the attachment assembly 55 may be manufactured from a malleable material such that the application of pressure at the main vent port 65 creates a seal. In other examples, the main vent port 65 may also be made of a rubber material such as an O-ring to form a seal. Alternatively, the main vent port 65 may be to interact with vent port having any of the features described above to form a seal.

It is to be appreciated that the outlet port 60 and the main vent port 65 may seal and co-operate to form a closed system to dispense the liquid from the liquid supply into the reservoir. In the present example, the main vent port 65 allows air to flow from the reservoir toward the liquid supply to replace the displaced liquid from the liquid supply. By maintaining the closed system, the amount of liquid entering the reservoir will not exceed the amount of volume available in the reservoir. In other examples, other mechanisms such as an automatic shutoff valve may be used to limit the amount of liquid entering the reservoir. Accordingly, this may be to reduce potential wastage of liquid during the filling process.

In the present example, the main vent port 65 is disposed at an end of conduit 80 through the attachment assembly 55. In particular, the conduit 80 is configured to provide a path for air to flow from the reservoir back to the liquid supply. In further examples, the main vent port 65 may be connected to other components such as a valve (not shown). In some other examples, the main vent port 65 may also vent to atmosphere where the filling process does not involve a closed system.

The plug 70 is disposed on the body of the attachment assembly 55 to seal a secondary vent. In the present example, the plug 70 seals the secondary vent when the attachment assembly 55 is in operation to mate the liquid supply with the reservoir. Upon completion of the filling process, the plug 70 may be displaced to break the seal with the secondary vent. It is to be appreciate that the seal of the plug 70 may be broken by a slight movement such as lifting the plug 70 away from the secondary vent. The secondary vent in the present example breaks a closed system and allows air to escape the reservoir to the external environment. Accordingly, pressure in reservoir preventing additional liquid from entering is relieved. Therefore, by breaking the seal between the plug 70 and the secondary vent, without significantly displacing the relative positions of the outlet port 60 to the receiving port of the reservoir allows the remaining liquid, such as liquid in the conduit 75 to be recovered by falling into the reservoir via the receiving port.

In the present example, a recess 85 may also be formed on the body of the attachment assembly 55 proximate to the plug. It is to be appreciated that the recess 85 is not particularly limited and may be a channel or other feature where material is removed using various techniques such as cutting or grinding away material. In other examples, the recess 85 may be formed during the original manufacturing process of the body of the attachment assembly 55. It is to be appreciated that the recess 85 may be to facilitate the breaking of the seal of the plug from the secondary vent. For example, if the recess 85 is close to the plug 70, the attachment assembly 55 may be moved a small amount in a lateral direction to allow air to escape from the secondary vent via the recess. In some examples, the attachment assembly 55 is placed into a position over the reservoir via tracks (not shown) such that the attachment assembly 55 may be moved along one dimension. Therefore, the recess 85 may facilitate breaking the seal between the plug 70 and the secondary vent to recover the liquid.

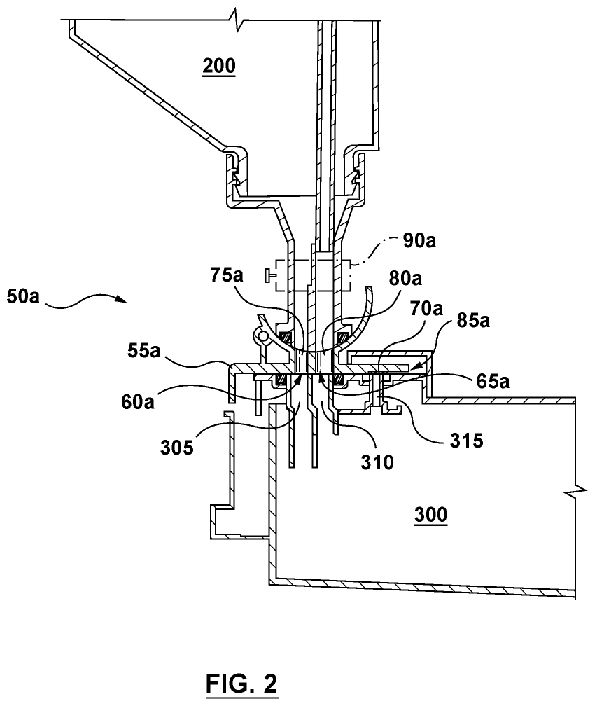

Referring to FIG. 2, another apparatus is generally shown at 50a. The apparatus 50a is to transfer liquid from a liquid supply 200 to a liquid reservoir 300. Like components of the apparatus 50a bear like reference to their counterparts in the apparatus 50, except followed by the suffix “a”. In the present example, the apparatus 50a includes an attachment assembly 55a, an outlet port 60a, a vent port 65a and a plug 70a. In addition, the apparatus 50a further includes a valve 90a to control the flow of liquid from the liquid supply 200 to the liquid reservoir 300.

In the present example, the attachment assembly 55a is to mate the liquid supply 200 connected to the apparatus 50a to the reservoir. The attachment assembly 55a forms a connection with the valve 90a from a side and is designed to mate with an interface of a reservoir 300 on the opposite side. The manner by which the attachment assembly mates with the interface of the reservoir is not particularly limited and may include manners discussed above. The attachment assembly 55a is not particularly limited and may be manufactured using a wide variety of materials. In the present example, the attachment assembly 55a is a plastic and may be manufactured using various techniques such as injection molding or 3-D printing. In other examples, the attachment assembly 55a may be manufactured from composite materials or metals and/or alloys such as aluminum, steel, titanium or other metals.

The outlet port 60a is disposed on the attachment assembly 55a. In the present example, the outlet port 60a is to dispense liquid from the liquid supply 200 via the valve 90a to a receiving port 305. Accordingly, the outlet port 60a may be designed to establish a sealed connection with the receiving port 305. The manner by which the outlet port 60a may establish the sealed connection is not particularly limited. For example, the outlet port 60a may include a raised edge extending beyond edges of the receiving port 305 to form a seal. As another example, the receiving port 60a may be manufactured from a malleable material such that the application of pressure at the outlet port 60a creates a seal. In other examples, the outlet port 60a may also be made of a rubber material such as an O-ring to form a seal. Alternatively, the receiving port 305 may have any of the features described above.

In the present example, the outlet port 60a is smaller than the receiving port 305. It is to be appreciated that the difference in size allows for easier alignment of the outlet port 60a over the receiving port 305 to reduce potential spillage of liquid. In addition, the oversize of the receiving port 305 allows for the outlet port 60a to be translated slightly, such as for breaking the seal with the secondary vent 315 as discussed in greater detail below. In other examples, the outlet port 60a may be a similar size to the receiving port 305 such that the small translation will have the outlet port 60a substantially aligned with the receiving port 305.

The outlet port 60a includes a conduit 75a through the attachment assembly 55a. In particular, the conduit 75a is configured to direct liquid from the liquid supply 200 via the valve 90a to the reservoir 300. Upon completion of the filling process, it is to be appreciated that some liquid may remain in the conduit 75a of the outlet port 60a when the flow of the liquid stops.

The main vent port 65a is disposed on the attachment assembly 55a. In the present example, the main vent port 65a is to receive air from a main vent 310 of the reservoir as the liquid enters the reservoir 300 via the outlet port 60a. Accordingly, the main vent port 65a may be designed to establish a sealed connection with the main vent 310. The manner by which the main vent port 65a may establish the sealed connection is not particularly limited. For example, the main vent port 65a may include a raised edge to seal around the main vent 310.

It is to be appreciated that the outlet port 60a and the main vent port 65a may co-operate to form a closed system to dispense the liquid from the liquid supply 200 into the reservoir 300. In the present example, the liquid supply 200 may be a hand-held bottle of liquid. In other examples, the liquid supply 200 may be from a larger container and may involve a pump to deliver the liquid to the outlet port 60a. The main vent port 65a allows air to flow from the reservoir 300 toward the liquid supply 200 to replace the displaced liquid from the liquid supply 200 entering the reservoir 300. By maintaining the closed system, the amount of liquid entering the reservoir will not exceed the amount of volume available in the reservoir. Accordingly, this may be to reduce potential wastage of liquid during the filling process.

The main vent port 65a is disposed at an end of conduit 80a through the attachment assembly 55a. In particular, the conduit 80a is configured to provide a path for air to flow from the reservoir 300 back to the liquid supply 200.

The plug 70a is disposed on the attachment assembly 55a and to seal a secondary vent 315. In the present example, the plug 70a seals the secondary vent 315 when the attachment assembly 55a is in operation to mate the liquid supply 200 with the reservoir 300. Upon completion of the filling process, the plug 70a may be displaced to break the seal with the secondary vent 315. It is to be appreciate that the seal of the plug 70a may be broken by a slight movement such as sliding the plug 70 along the surface of the reservoir 300. The secondary vent 315 in the present example breaks the closed system and allows air to escape the reservoir 300 to the external environment. Accordingly, pressure in reservoir that stops the flow of additional liquid into the reservoir 300 is relieved. Therefore, by breaking the seal between the plug 70a and the secondary vent 315 without significantly displacing the relative positions of the outlet port 60a to the receiving port 305 allows any remaining liquid, such as liquid in the conduit 75a of the outlet port 60a to be recovered by falling into the reservoir 300 via the receiving port 305. It is to be appreciated that by oversizing the receiving port 305 relative to the outlet port 60a allows for the liquid to fall into the receiving port 305 despite a small translation of the attachment assemble 55a relative to the reservoir 300 to break the seal of the plug 70a.

In the present example, a recess 85a may also be formed on the attachment assembly 55a proximate to the plug. It is to be appreciated that the recess 85a is not particularly limited and may be a channel or other feature where material is removed using various techniques such as cutting or grinding away material. In other examples, the recess 85a may be formed during the original manufacturing process of the attachment assembly 55a. In further examples, the recess 85a may be omitted and the plug 70a be disposed at the end of the attachment assembly 55a such that a small movement uncovers the secondary vent 315a.

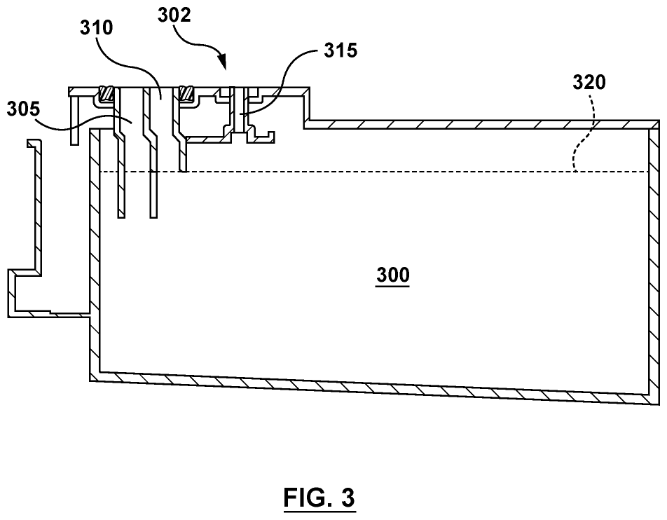

Referring to FIG. 3, the reservoir 300 to store the liquid, such as ink, is shown in greater detail. In the present example, the reservoir 300 includes an interface 302, a receiving port 305, a main vent 310, and a secondary vent 315.

In the present example, the interface 302 is to mate with a liquid source, such as the apparatus 50a and the liquid supply 200. For example, the liquid source may include the apparatus 50a receiving liquid, such as ink, from the liquid supply 200. The manner by which the interface 302 mates with the attachment assembly 55a is not particularly limited and may include various features to interact with complementary features. For example, the interface 302 may include guides and bosses (not shown) to mate with complementary guides and bosses on the attachment assembly 55a. In other examples, the interface 302 may mate with the attachment assembly 55a using other attachment mechanisms. For example, the interface 302 may include a connector or fastener, such as a clipping mechanism, a magnetic coupling mechanism, a screw, or bolt. In another example, the interface 302 may be designed with dimensions to mate with the attachment assembly 55a using a friction fit.

The receiving port 305 is to receive the liquid, such as ink, from the liquid source. In the present example, the liquid source may be the apparatus 50a receiving liquid, such as ink, from the liquid supply 200. In addition, the receiving port 305 may be designed to form a sealed connection with an outlet port 60a of the apparatus 50a. The manner by which the receiving port 305 may establish the sealed connection is not particularly limited. For example, the receiving port 305 may include a raised edge extending beyond the edges of the outlet port 60a to form a seal. As another example, the receiving port 305 and/or the interface 302 proximate to the receiving port 305 may be manufactured from a malleable material such that the application of pressure causes a deformation to establish a seal. In other examples, the receiving port 305 may include a rubber material such as an O-ring to form a seal.

The main vent 310 is to exchange air from the reservoir 300 as liquid enters from the source, such as via the attachment apparatus 50a. It is to be appreciated that the amount of air exchanged via the main vent 310 is about the same as the amount of liquid received via the receiving port 305 by volume. In the present example, the main vent 310 exchanges air via a main vent port 65a of the apparatus 50a. However, in other examples, the main vent 310 may release air directly to the liquid supply 200 without passing through the apparatus 50a. In another example, the main vent 310 may release air to the external environment.

In the present example, the main vent 310 may be to form a seal with the main vent port 65a of the apparatus. Accordingly, the main vent 310 may allow for air to flow from the empty space in the reservoir 300 to the liquid source. For example, the liquid source may include the apparatus 50a and the liquid supply 200. In this example, the main vent 310 may be designed to establish a sealed connection with the main vent port 65a. The manner by which the sealed connection may be established is not particularly limited.

Furthermore, the main vent 310 and the receiving port 305 may co-operate to form a closed system to receive the liquid from a liquid source that may include the liquid supply 200. In the present example, the liquid supply 200 may be a hand-held bottle of liquid where liquid dispensed from the liquid supply 200 is to be replaced with an approximately equal volume of air from the reservoir 300.

Therefore, it is to be appreciated that in this example, as the liquid is dispensed into the reservoir 300, the level of liquid in the reservoir will eventually rise to the location of the main vent 310, which is positioned proximate to the top of the reservoir 300. However, the main vent 310 is positioned a small distance below the top of the reservoir. Accordingly, as the reservoir 300 receives liquid from the receiving port 305, the liquid level will rise until the main vent 310 is blocked with the liquid. It is to be appreciated that this level of liquid in the reservoir may be defined as the fill limit 320. Since there is a small distance that the main vent 310 is lowered in the reservoir, an air pocket may be formed above the fill limit 320. Since the air in the air pocket does not have an escape path, the air pocket applies back pressure on any liquid from the liquid source.

The secondary vent 315 is to release air from the reservoir 300 at a second location. The secondary vent 315 is to provide an alternative location from which the reservoir 300 may be vented in the event that releasing air from the main vent 310 is obstructed. During the filling process, the secondary vent 315 is to be sealed when the reservoir 300 is receiving liquid from the liquid source, which may include the apparatus 50a and the liquid supply 200. Furthermore, it is to be appreciated that after the filling process is completed, the secondary vent 315 is to be opened prior to the detachment of the liquid source from the interface 302 to equalize the pressure between the internal chamber of the reservoir 300 and the external environment. In this example, detachment of the liquid source from the interface 302 may occur when the liquid source is completely removed from a region proximate to the interface 302 such that the outlet port 60a on longer aligns with the receiving port 305. It is to be appreciated that once detached, any liquid remaining in the outlet port 60a may fall out and may be lost.

Continuing with the example above where liquid is received by the reservoir 300 until the liquid level reaches the fill limit 320, the air above the fill limit 320 may create an air pocket. In the present example, the reservoir 300 may be designed such that the air pocket may be positioned at the secondary vent 315 when the liquid level is at the fill limit 320. Accordingly, in the present example, the secondary vent 315 may be used to release air from air pocket in the reservoir 300 after the liquid level reaches the fill limit. Therefore, additional liquid, such as liquid that may be retained in the attachment assembly 55a may fall into the reservoir while the liquid level rises above the fill limit 320 by a small amount.

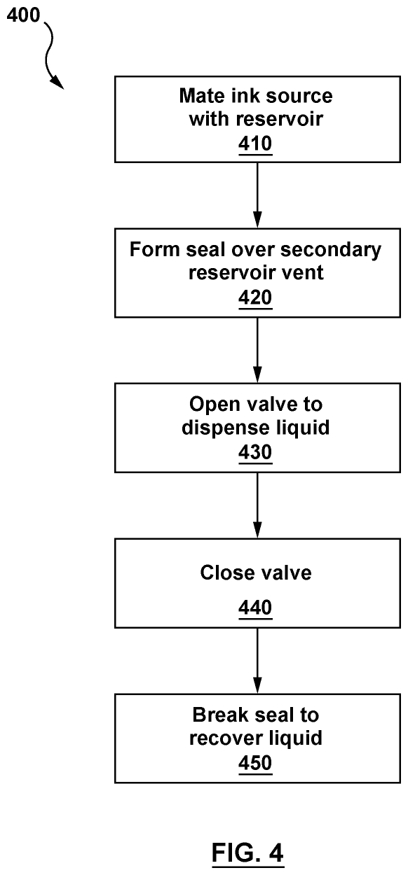

Referring to FIG. 4, a flowchart of a method of recovering liquid from an apparatus is shown at 400. In order to assist in the explanation of method 400, it will be assumed that method 400 may be performed with the apparatus 50a in combination with a liquid supply 200 and a reservoir 300. Indeed, the method 400 may be one way in which attachment apparatus 50a may be operated. Furthermore, the following discussion of method 400 may lead to a further understanding of the apparatus 50a along with their various components.

Beginning at block 410, a liquid source is mated with the reservoir 300. It is to be appreciated that the liquid source is not particularly limited and may be any type of liquid source capable of dispensing liquid. In the present example, the liquid source includes the apparatus 50a and the liquid supply 200. In addition, the manner by which the liquid source and the reservoir 300 is mated is not particularly limited and may involve any connection that may be used to dispense liquid into the reservoir 300. In the present example, the mating of the liquid source with the reservoir 300 involves aligning the attachment assembly 55a such that the outlet port 60a is in communication with the receiving port 305 and that the main vent port 65a is in communication with the main vent 310.

Next, at block 420, a seal is formed over a secondary vent 315 using the plug 70a. The manner by which the seal is formed is not limited and may include various manners to cover and/or plug the secondary vent 315 such that air is block from escaping from the reservoir 300 via the secondary vent 315. Accordingly, in the present example of a closed system, air from the reservoir is to be exchanged by the main vent 310 to the liquid supply 200. It is to be appreciated that block 420 may be carried out simultaneously with block 410 and that part of the mating process between the liquid source and the reservoir may involve sealing the secondary vent 315.

The valve 90a to control the flow of liquid from the liquid supply 200 to the liquid reservoir 300 is opened at block 430. It is to be appreciated that upon opening the valve 90a, liquid may begin flowing from the liquid supply 200 to the reservoir. The manner by which the valve 90a is operated is not particularly limited. In the present example, the valve 90a may be a ball valve or any other type of valve to control the flow of liquid, such as a gate valve, an inverted ball valve, or a poppet valve. The first position is the dispense position to dispense liquid from the liquid supply 200 to the reservoir. The second position is the closed position where the valve seals the liquid supply 200 from the reservoir 300.

Block 440 involves closing the valve 90a when the liquid level in the reservoir 300 reaches the fill limit 320. It is to be appreciated that as the liquid is dispensed into the reservoir 300 when the valve 90a is opened at block 430, liquid enters the reservoir 300 via the receiving port 305 and air is allowed to escape via the main vent 310. In the present example of a closed system, the air moves through the main vent port 65a through the valve 90a and into the liquid supply 200 to displace the liquid that is dispensed into the reservoir. As the liquid in the reservoir reaches the fill limit 320, air cannot be exchanged through the main vent 310. In addition, since the secondary vent 315 is sealed, an air pocket may form and to stop further liquid from entering the reservoir 300.

It is to be appreciated that by stopping the flow of liquid from the liquid supply, liquid in the conduit 75a of the outlet port 60a may be trapped upon closing the valve 90a to the closed position. Therefore, this results in a small amount of liquid not being dispensed to the reservoir 300 when carrying out the fill process. In the present example, the valve 90a in the closed position disengages the flow of liquid from the liquid supply 200 to the conduit 75a. The manner by which the flow is disengaged is not limited. For example, the valve 90a may move the tube from the liquid supply 200 away from the conduit 75a. In the present example, the valve 90a also exposes the conduit 75a of the outlet port 60a to the external environment or atmosphere in the closed position by moving the tube from the liquid supply 200 away from the conduit.

Block 450 breaks the seal formed at block 420 to recover the trapped liquid in the attachment assembly 55a. Continuing with the example above, liquid was trapped in the conduit 75a of the outlet port 60a. In addition, liquid is also trapped in the receiving port 305 above the fill limit 320. Once the seal formed by the plug 70a over the secondary vent 315 is broken, air trapped in the air pocket is released to the external environment causing the trapped liquid to fall into the reservoir 300 due to gravity since it is exposed to atmosphere when the valve 90a is in the closed position.

It is to be appreciated that in order for the liquid to successfully fall into the reservoir 300, the outlet port 60a is to be substantially still aligned with the receiving port 305. Accordingly, the seal is to be broken when the attachment assembly 55a is substantially mated with the reservoir 300 and prior to fully detaching the apparatus 50a from the reservoir. In some examples, block 450 may be carried out by a slight translation of the attachment assembly 55a and using the slight oversize of the receiving port 305 to receive the liquid from the outlet port 60a.

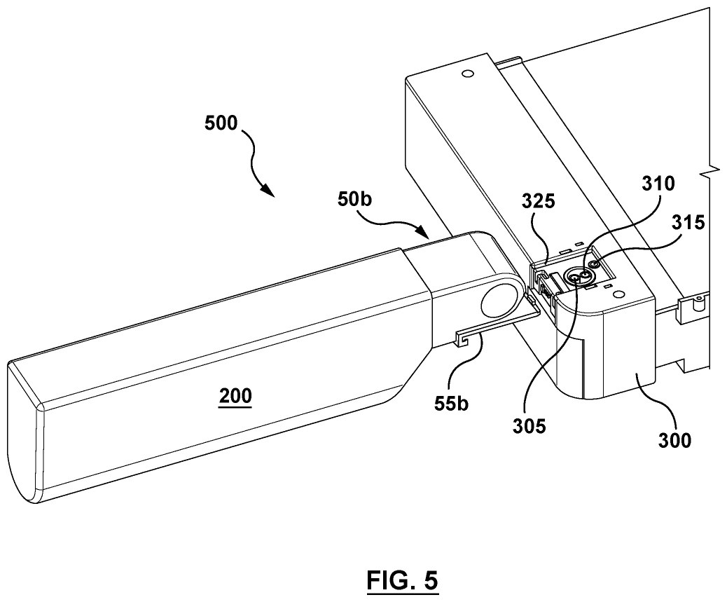

Referring to FIG. 5, an example of a system to refill the reservoir 300 with liquid from the liquid supply 200 is generally shown at 500. In this example, the liquid supply 200 is a bottle of liquid, such as ink, used to fill the reservoir 300. The system includes an apparatus 50b to transfer or dispense the liquid from the liquid supply 200 to the reservoir. Like components of the apparatus 50b bear like reference to their counterparts in the apparatus 50, except followed by the suffix “b”. In the present example, the apparatus 50b includes an attachment assembly 55b to mate with the interface 302 of the reservoir 300. Furthermore, it is to be appreciated that the attachment assembly 55b is configured to be received by a guide 325 of the reservoir 300 such that complementary features of the attachment assembly 55b mate with the receiving port 305, the main vent 310, and the secondary vent 315.

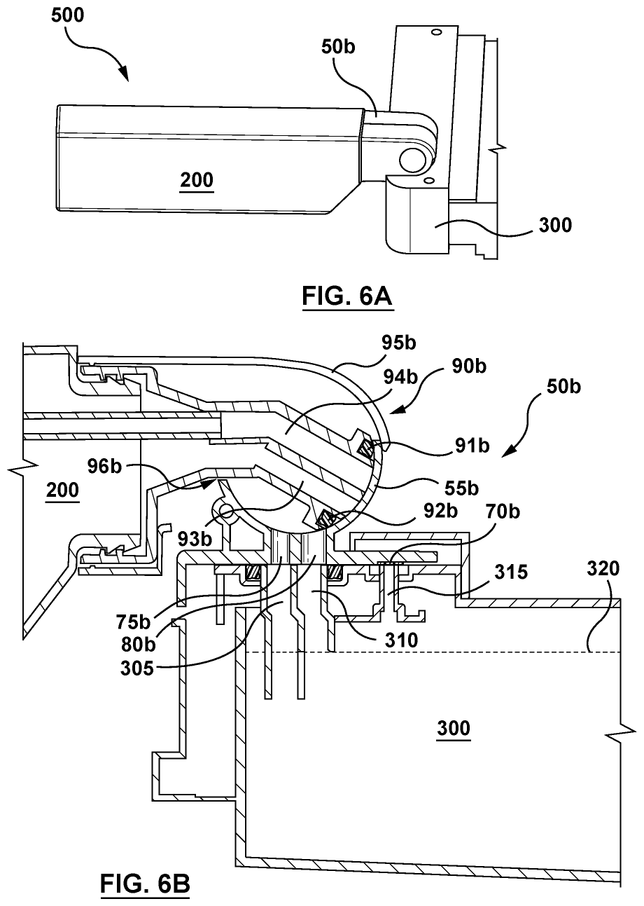

Referring to FIGS. 6A and 6B, the system 500 is shown with the liquid source connected to the liquid reservoir 300. In particular, the apparatus 50b is mated with the reservoir for the filling process. In the present example, the apparatus 50b includes a valve 90b in the closed position. In the present example, the valve 90b is an inverted ball valve. The valve 90b includes seals 91b and 92b for forming a slidable seal with a surface of the attachment assembly 55b. The manner by which the seals 91b and 92b operate is not limited. For example, the seals 91b and 92b may be rubber O-rings pressed against the surface of the attachment assembly 55b. It is to be appreciated that the seals 91b and 92b are to isolate the tube 93b for delivering the liquid from the liquid supply to the conduit 75b and the tube 94b for receiving the air from the reservoir separated from the external environment such that liquid cannot escape from the liquid supply 200.

The valve 90b also includes a cover 95b to protect the internal components of the valve 90b. In addition, the cover 95b may interact with a portion of the attachment assembly 55b to apply further pressure on the seals 91b and 92b to maintain the formed seal. For example, the cover 95b may be malleable and apply a spring force to pull the seals 91b and 92b against the opposite surface of the attachment assembly 55b. The cover 95b may also include a feature to interact with the attachment assembly 55b to stop the valve 90b in the closed position as shown in FIG. 6B. In particular, the closed position leaves a gap 96b between the tube 93b and the attachment assembly 55b such that the top of the conduits 75b and the 80b are expose to the external environment and atmosphere.

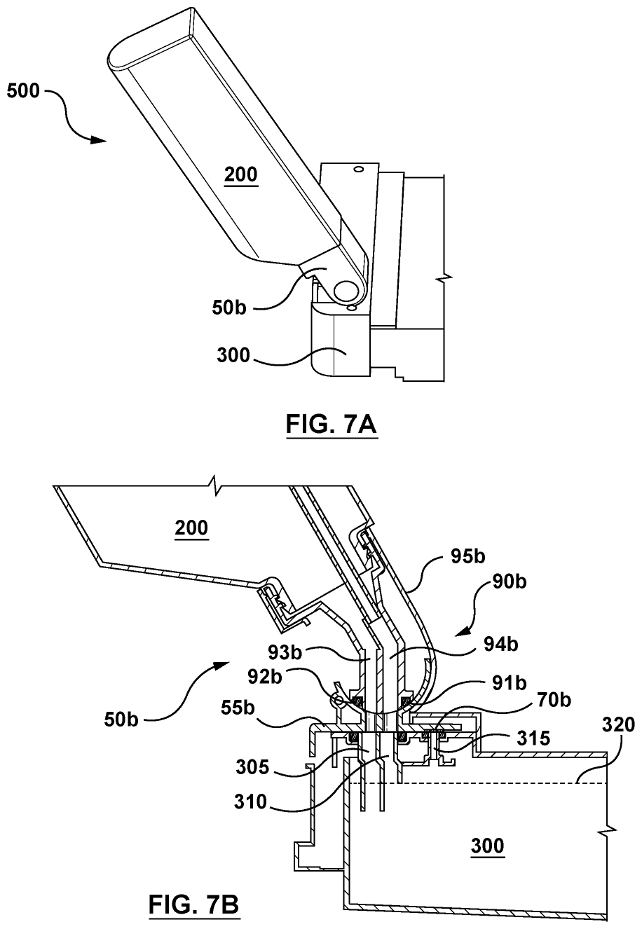

Referring to FIGS. 7A and 7B, the system 500 is shown with valve 90b in a dispensing position to connect the liquid supply 200 to the reservoir 300. It is to be appreciated that the valve 90b is moveable between the dispensing position shown and the closed position described above. The manner by which the valve is moved between the two positions is not particularly limited. In the present example, the seals 91b and 92b are slidable and slide between the two positions with an application of force. Furthermore, in the present example, the cover 95b may guide the movement of the valve 90b between the two positions.

In the present example, the dispensing position aligns the conduits 75b and 80b with the receiving port 305 and the main vent 310 of the reservoir. The seals 91b and 92b isolate the liquid supply 200 and the reservoir 300 such that liquid may be dispensed from the liquid supply 200 to the reservoir 300 and that air from the reservoir 300 is received by the liquid supply to replace the volume of the dispensed liquid. Accordingly, as the reservoir 300 receives liquid from the receiving port 305, the liquid level will rise until the main vent 310 is blocked with the liquid. It is to be appreciated that this level of liquid in the reservoir may be defined as the fill limit 320. Since there is a small distance that the main vent 310 is lowered in the reservoir, an air pocket may be formed above the fill limit 320.

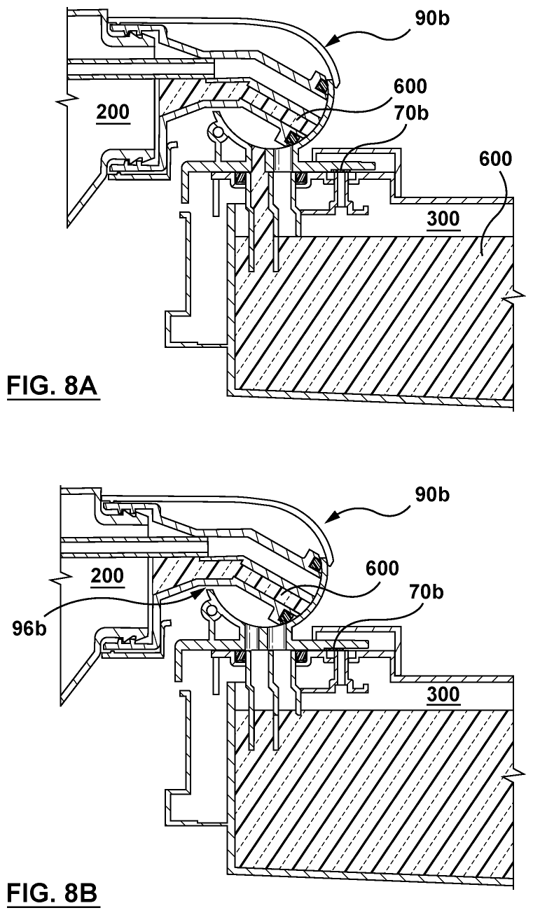

It is to be appreciated that upon reaching the fill limit 320, liquid 600 from the liquid supply 200 occupies the tube 93b as well as the conduit 75b of the outlet port 60b. Upon filling the reservoir 300 to the fill limit 320, the valve 90b is to be moved to the closed position as shown in FIG. 8A. Accordingly, an amount of the liquid 600 is retained in the outlet port 60b of the attachment assembly as well as in the conduit 75b. This amount of the liquid 600 is trapped and may be spilled upon rapid detachment of the apparatus 50b from the reservoir which may result in wastage and creating a mess.

FIG. 8B shows the seal between the plug 70b and the secondary vent 315 being broken. It is to be appreciated that upon breaking the seal on the secondary vent 315, air from the air pocket above the fill limit 320 may escape. Since the conduit 75b is exposed to atmosphere in the closed position via the gap 96b, the liquid 600 trapped in the conduit 75b may fall into the reservoir 300 when the air from the air pocket is allowed to escape via the secondary vent.

It should be recognized that features and aspects of the various examples provided above may be combined into further examples that also fall within the scope of the present disclosure.

What is claimed is:

1. An attachment assembly comprising:
a body to mate a liquid supply with a reservoir;
an outlet port formed in the body, wherein the outlet port is to dispense liquid from the liquid supply to a receiving port of the reservoir;
a main vent port formed in the body, wherein the main vent port is to facilitate reception of the liquid via the receiving port; and
a plug disposed on the body, wherein the plug is to seal a secondary vent when the body is mated with the reservoir, and wherein the plug is to break a seal with the secondary vent prior to detachment of the body to recover the liquid in the outlet port.

2. The attachment assembly of claim 1, further comprising a recess formed on the body proximate to the plug, wherein the recess is to allow air to flow through the secondary vent.

3. The attachment assembly of claim 1, wherein the main vent port is to receive air from the reservoir as the liquid enters the reservoir.

4. The attachment assembly of claim 3, wherein the main vent port is to exchange air between the reservoir and the liquid supply.

5. The attachment assembly of claim 4, wherein the main vent port is to maintain a closed system between the liquid supply and the reservoir.

6. The attachment assembly of claim 1, wherein the plug is formed on the body.

7. The attachment assembly of claim 1, wherein the plug is made from a rubber material.

8. A reservoir comprising:
an interface to mate with a liquid source;
a receiving port to receive liquid from the liquid source;
a main vent to exchange air from the reservoir as the liquid enters the reservoir from the liquid source, wherein a volume of air exchanged is substantially equivalent to a volume of liquid received; and
a secondary vent to release air from the reservoir, wherein the secondary vent is to be sealed when receiving liquid from the liquid source, and wherein the secondary vent is to be opened prior to detachment of the liquid source from the interface.

9. The reservoir of claim 8, wherein the main vent allows air to flow from the reservoir to the liquid source to maintain a closed system to dispense the liquid.

10. The reservoir of claim 9, wherein the main vent is to be blocked when the liquid reaches a fill limit, wherein the liquid at the fill limit leaves an air pocket at the secondary vent.

11. The reservoir of claim 10, wherein the secondary vent is to release the air from the air pocket after the liquid reaches the fill limit.

12. A method comprising:
mating a liquid source with a reservoir, wherein the liquid source includes an attachment assembly and a liquid supply, wherein an outlet port is in communication with a receiving port of the reservoir, and wherein a main vent port is in communication with a main vent of the reservoir;
forming a seal over a secondary vent with a plug; and
breaking the seal to recover a trapped amount of liquid in an attachment assembly prior to detachment of the liquid source from the reservoir.

13. The method of claim 12, wherein breaking the seal releases air from an air pocket such that the trapped amount of liquid falls into the reservoir.

14. The method of claim 13, wherein breaking the seal comprises moving the attachment assembly to slide the plug away from secondary vent.

15. The method of claim 13, wherein breaking the seal comprises moving the attachment assembly to lift the plug away from secondary vent.
